(19) United States
(12) Patent Application Publication
(10) Pub. No.: US 2026/0164076 A1
(43) Pub. Date: Jun. 11, 2026

(54) Method for managing the recording of a content item comprising a main content item and a secondary content item

(71) Applicant: Orange, Issy-les-Moulineaux (FR)

(72) Inventors: Olivier GASTE, CHATILLON CEDEX (FR); Hervé MARCHAND, CHATILLON CEDEX (FR)

(21) Appl. No.: 19/410,248

(22) Filed: Dec. 5, 2025

(30) Foreign Application Priority Data
Dec. 6, 2024 (FR) FR2413555

(51) Int. Cl. H04N 21/2747; H04N 21/433

(52) U.S. Cl. CPC H04N 21/2747; H04N 21/4334

(57) ABSTRACT

A method for managing recording of a multimedia content item including a first content item, called main content item, and a second content item, called secondary content item, the content items including temporal segments having respective network access addresses from which the segments are downloaded via a communication network. The method includes, following receipt of a request to record the content item, recording segments or network addresses depending on whether the segments in question concern the main content item or the secondary content item.

### CROSS REFERENCE TO RELATED APPLICATIONS

The present application claims priority to and the benefit of French Patent Application No. FR2413555, filed Dec. 6, 2024, the entire content of which is incorporated herein by reference.

### TECHNICAL FIELD

The field of the disclosure is that of digital multimedia content items, specifically digital audio and/or video content items.

More specifically, the disclosure relates to a method for managing the recording of a digital content item with a view to subsequent playback by a playback device.

The recording is carried out on a medium such as a storage server. The server may be located remotely from the rendering device, or even locally.

It will be seen in one exemplary embodiment described below that the playback device chosen to illustrate the invention is a digital television decoder (or set-top box); the decoder concerned here is capable of requesting access to a content item having multiple available qualities. Such content items are for example content items used in an HTTP adaptive streaming (HAS) context in which the content items are divided into segments, each segment being available with multiple encoding rates associated with respective rendering qualities.

### PRIOR ART

Access to a multimedia content item, such as television or video on demand, over the Internet is nowadays possible for the majority of multimedia content playback terminals.

The playback device, for example a decoder, generally sends a request to a server, indicating a chosen multimedia content item. The decoder in turn receives the requested multimedia content item. In the context of a local area communication network, such a request transits via a network access gateway, for example a residential/home gateway.

The playback device is designed to receive these digital content items in the form of multimedia data and to request rendering on a rendering device. This rendering consists in supplying, in the playback device, the digital content item to the rendering device in a form accessible to the user. For example, received data corresponding to a video are generally decoded by the content playback device and then rendered on the rendering device in the form of a display of the corresponding video with its associated soundtrack. Below, for the sake of simplification, the digital content item will be likened to a video and the rendering by the device, or consumption by the user of the device, will be likened to viewing on the screen of the device.

The broadcasting of digital content over the Internet is often based on client-server protocols of the HTTP (Hypertext Transport Protocol) family. In particular, streaming digital content makes it possible to transport and consume data in real time, that is to say the digital data are transmitted over the network and decoded by the playback device as they arrive. The playback device receives and stores some of the digital data in a buffer memory before commanding rendering on the rendering device. This form of distribution is particularly useful when the bit rate available to the user is not guaranteed for real-time transfer of the video. The consumption of digital content items via HTTP adaptive streaming is tending to become more common. HAS is used in particular by many streaming services, but also by certain digital television decoders, or set-top boxes, which use it to access delinearized content items such as video on demand (VOD), to replay television programs, or even to provide services such as Network PVR (Network Personal Video Recorder, i.e. a service for recording digital content items, the recording being performed by the content provider itself rather than in the home of the end user).

The nPVR functionality allows a user of a live TV service to record a content item being broadcast live to a network storage space. This content item thereby recorded may then be consumed by this user from any Internet access point. This nPVR space has a limited storage capacity (for example 20 GB), and the user therefore has the option to record content items to within the authorized limit.

When the user accesses a content item that has been recorded, the requested content item, called main content item, is rendered, but the various secondary content items, such as advertisement tunnels broadcast during the broadcasting of the main content item, are rendered as well.

One problem related to the storage of secondary content items, which are unrequested or even undesired content items, is that they may represent a non-negligible share of the recorded content item volume. Indeed, depending on the channels, types of content item or even schedules, advertising sequences may make up 20 to 25% of the duration of the content item recorded on the nPVR server. Moreover, when a user accesses a recorded content item, they may watch it with a significant time delay compared to when it was broadcast. Ultimately, advertisements broadcast in connection with a content item, and which are therefore recorded, may no longer be up to date.

### SUMMARY

According to one functional aspect, the disclosure relates to a method for managing the recording of a multimedia content item including a first content item (Cp), called main content item, and a second content item (Cs), called secondary content item, the content items comprising temporal segments having respective network access addresses from which the segments are downloaded via a communication network, characterized in that it comprises, following the receipt of a request to record the content item, recording segments or network addresses depending on whether the segments in question concern the main content item or the secondary content item.

According to an aspect of the disclosure, all segments destined to be downloaded when accessing a content item are not downloaded; indeed, when the content item comprises a main content item and a secondary content item such as an advertisement, segments relating to the secondary content item are not recorded; instead of the segments, addresses are recorded.

Since the size of the addresses is much smaller than the size of a segment, the amount of stored data resulting from a request to access a content item is greatly reduced. Furthermore, due to the decrease in size of the transmitted data, the bandwidth occupied for the transmission of the content item with a view to recording same is reduced compared to the prior art.

Therefore, another non-negligible advantage, because a network address is recorded instead of a segment, the secondary content item may vary over time and be adapted to a user profile. For example, if the secondary content item is an advertisement, and the user accessing the content item is a child, the downloaded advertisement may be a targeted advertisement, for example an advertisement relating to toys.

According to a first particular mode of implementation of the disclosure, with the segments being described in a manifest, the method comprises a step of distinguishing between described segments relating to the first content item and those relating to the secondary content item. The distinction is therefore made on the fly by the playback device. This mode avoids any processing on the issuer side to distinguish between segments relating to the main content item or to the secondary content item. According to one variant, the processing could be carried out by the issuer of the content segments.

Assuming that the secondary content item comprises a plurality of sub-content items, the method of an aspect of the disclosure may be applied to all sub-content items. According to one possible variant, the transmission step is carried out only for some of the sub-content items. This mode is beneficial when the secondary content item is a content item that does not need to be linked to a user profile. Such a secondary content item is for example a message other than advertising content, for example relating to a campaign to fight a disease and intended for the greatest possible number of people.

According to a second particular mode of implementation of the disclosure, which may be implemented as an alternative or in addition to the preceding mode, the secondary content item changes over time. Indeed, an aspect of the disclosure is entirely suitable for secondary content items that change over time, such as advertisements.

According to another, third particular mode of implementation of the disclosure, which may be implemented as an alternative or in addition to the preceding modes, the stored addresses are erased from memory beyond a certain duration. This mode is beneficial when the secondary content item has been rendered a certain number of times. The erasure makes it possible to save memory space.

According to another, fourth particular mode of implementation of the disclosure, which may be implemented as an alternative or in addition to the preceding modes, the network addresses are replaced by segments of a secondary content item later on. This mode makes it possible to record a content item that includes a main content item and a secondary content item that no longer has to be varied over time.

According to one hardware aspect, an aspect of the disclosure relates to a management entity for managing the recording of a multimedia content item including a first content item, called main content item, and a second content item, called secondary content item, the content items comprising temporal segments having respective network access addresses from which the segments are downloaded via a communication network, characterized in that it comprises a recording module able, following the receipt of a request to record the content item, to record segments or network addresses depending on whether the segments in question concern the main content item or the secondary content item.

According to another hardware aspect, an aspect of the disclosure relates to a multimedia content storage server comprising an entity as defined above.

According to another hardware aspect, an aspect of the disclosure relates to a multimedia content playback device comprising an entity as defined above.

According to another hardware aspect, an aspect of the disclosure relates to a computer program able to be implemented on a multimedia content playback device, the program comprising code instructions that, when it is executed by a processor, carries out the steps of the method that are defined in the method defined above.

According to another hardware aspect, an aspect of the disclosure relates to a data medium on which at least one sequence of program code instructions for executing a method as defined above has been stored.

The data medium may be any entity or device capable of storing the program. For example, the medium may comprise a storage means, such as a RAM memory, a ROM memory, for example a CD-ROM or a microelectronic circuit ROM, or else a magnetic recording means, such as a hard disk. Moreover, the information medium may be a transmissible medium such as an electrical or optical signal, which may be routed via an electrical or optical cable, by radio or by other means. The program according to an aspect of the disclosure may in particular be downloaded over the Internet. As an alternative, the information medium may be an integrated circuit in which the program is incorporated, the circuit being designed to execute or to be used in the execution of the method in question.

Lastly, it should be pointed out here that, in the present text, the term “module” or “entity” may correspond equally to a software component or to a hardware component or to a set of software and hardware components, a software component itself corresponding to one or more computer programs or subroutines or, more generally, to any element of a program able to implement a function or a set of functions such as described for the modules in question. In the same way, a hardware component corresponds to any element of a hardware assembly that is able to implement a function or a set of functions for the module in question (integrated circuit, chip card, memory card, etc.).

### BRIEF DESCRIPTION OF THE DRAWINGS

The disclosure will be better understood on reading the following description, which is given by way of example and with reference to the appended drawings, in which:

FIG. 1 shows a computer system in which an aspect of the disclosure may be implemented.

FIG. 2 schematically illustrates the hardware structure of a storage server including a management entity according to one embodiment of the disclosure;

FIG. 3 presents a schematic view of the various segments of a main content item;

FIG. 4 presents a view of the data exchanges between the content server and the storage server networked according to one embodiment of the disclosure;

FIG. 5 presents an overview of the result of a content recording phase; the recording comprising content segments relating to the main content item and network addresses relating to the secondary content item.

### DETAILED DESCRIPTION OF ILLUSTRATIVE EMBODIMENTS OF THE DISCLOSURE

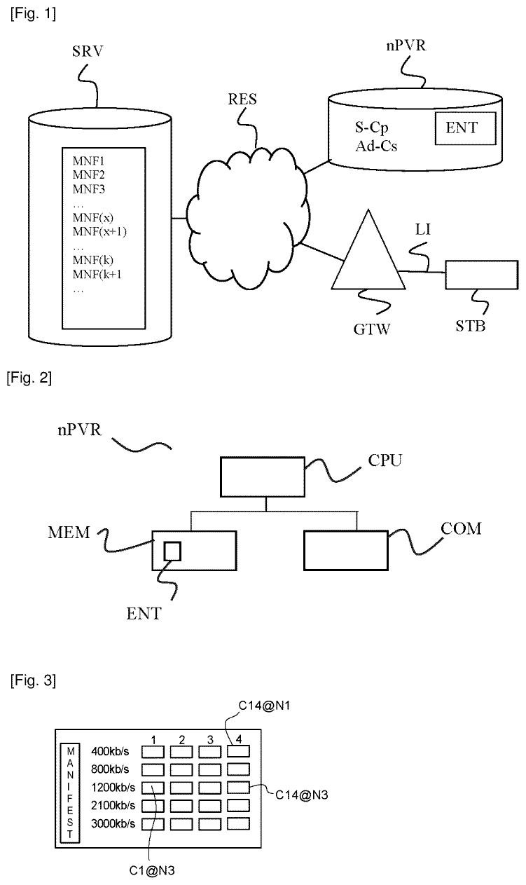

FIG. 1 shows a computer system SYS in which a content distribution network, which is called a CDN by those skilled in the art, is implemented, from which content items are transmitted to client devices or content playback devices and manifests associated with the multimedia content items are transmitted.

In our example, the system SYS comprises a single playback device STB. However, the disclosure applies to any number of playback devices.

The playback device is for example a digital playback device such as a decoder.

The multimedia content item targeted here is a video content item corresponding for example to a television channel broadcasting what are referred to as live television programs, that is to say those broadcast in real time. A live program may be a program that is captured live (for example a sports event) or that has already been captured (for example a television program recorded by the channel).

In our example, the playback device STB is connected to a rendering terminal TV such as a television.

In our example, the playback device STB is connected to a port of the rendering device TV; the playback device STB and the rendering device TV could also form one and the same device.

In our example, the playback device STB is located in a local area network LAN managed by a home gateway GTW. The context of the local area network is given by way of example and could easily be transposed to a best-effort Internet network, a company network, etc. It will be seen hereinafter that the playback device STB comprises a first management entity ENT1.

The gateway GTW is able to communicate via a communication link LI, which may be a telecommunications network such as a wide area network WAN known to those skilled in the art.

The computer system SYS implements a content distribution network, called a CDN by those skilled in the art, from which content items are transmitted to client devices or content playback devices STB.

The CDN network consists of servers networked in the wide area network; these servers interact in order to make multimedia content items available to users in unicast mode. In order to simplify the disclosure, a single content server SRV will be shown in FIG. 1 to represent the CDN. The content server SRV is located, in our example, in the wide area network WAN referenced RES.

The content server SRV receives for example channels of digital-television content items originating from a television broadcast network (not shown) and makes them available to client terminals, here the playback device STB, in real time.

In our example, the content items Cp are made available in unicast mode in a given format. Such a content item Cp is for example a content item downloaded in adaptive streaming mode. The MPEG-DASH (Dynamic Adaptive Streaming over HTTP) standard is a format standard for audiovisual broadcast over the Internet; this standard is based on preparing the content item in various representations of variable quality and bit rate, which are divided into segments of short duration (of the order of a few seconds), also called “chunks” by those skilled in the art. Each of these segments is made available individually by way of a protocol for exchange between the rendering terminal and the server providing multimedia content items. The protocol mainly targeted is the HTTP protocol, but other protocols (for example FTP) may also be used. The organization of the segments and the associated parameters are published in a manifest in the XML format. The details of this form of download will not be gone into further since they are irrelevant to the disclosure.

One example of a manifest or manifest file (MPD) according to the MPEG-DASH standard and containing the description of content items available in three different qualities (N1=512 kb/s, N2=1024 kb/s, N3=2048 kb/s) of the fragmented (or segmented) content items is presented in Appendix 1. This simplified manifest describes digital content items in an XML (extended Markup Language) syntax, comprising a list of content items in the form of segments that are conventionally described between a start tag (<SegmentList>) and an end tag (</SegmentList>). The division into segments makes it possible in particular to adapt finely to fluctuations in bandwidth. Each segment corresponds to a certain duration (“duration” field) with multiple quality levels, and allows their addresses (URL-Uniform Resource Locator) to be generated. This generation is performed, in this example, using the elements “BaseURL” (“HTTP://server.com”), which indicates the address of the content server, and “SegmentURL”, which lists the complementary portions of the addresses of the various segments:
“Cp_512kb_1.mp4” for the first fragment of the content item “Cp” at 512 kilobits per second (“kb”) in the MPEG-4 format (“mp4”),
“Cp_512kb_2.mp4” for the second fragment,
etc.

FIG. 2 shows an architecture of an nPVR storage server. This nPVR storage server comprises, as is conventional, memories MEM associated with a processor CPU. The memories may be read-only memories (ROMs) or random access memories (RAMs) or flash memories.

The nPVR storage server may transmit a content item to be rendered to the STB via the network RES and the gateway GTW.

The playback device STB communicates with the gateway GTW via an Ethernet module for wired local communication or via a Wi-Fi radio module for wireless local communication with the home gateway GTW.

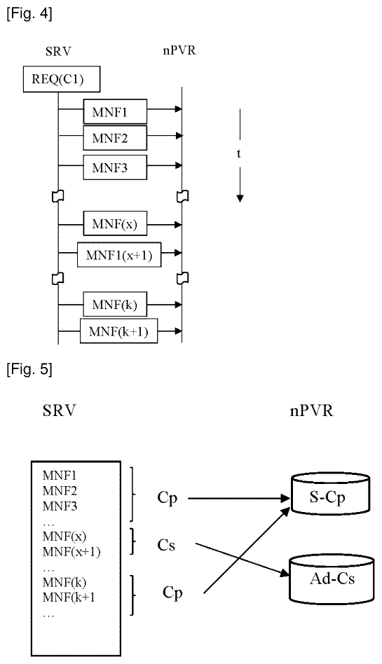

A schematic view of a main content item Cp divided into segments and stored in the content server SRV will now be presented for informational purposes in relation to FIG. 4. More specifically, the HAS content server presents a video Cp in the form of segments C1i@Nj that are encoded at various encoding rates Nj, the index i denoting a temporal identifier of the segment C1i@Nj.

The HAS module, called the conventional form of download below, of the playback device STB is responsible for retrieving the segments from the HAS content server, choosing the video quality Nj according to the available network resources. The way in which the HAS module chooses the encoding rate for the next video segment to be downloaded is not described in more detail here. It will be recalled that, more often than not, the general principle of such algorithms is based on downloading a first segment at the lowest encoding rate proposed in the manifest, and on evaluating the time to retrieve this first segment. On that basis, the HAS module evaluates whether, according to the size of the segment and the time taken to retrieve it, network conditions permit the next segment to be downloaded at a higher encoding rate. Certain algorithms are based on a gradual increase in the quality level of the downloaded content segments; others propose riskier approaches, with jumps in the levels of the encoding rates for the successive segments.

In the conventional case, if a video segment lasts three seconds, it must not take the HAS module more than 3 seconds to retrieve the segment, in order to permit the playback device STB to render the content item without interruption. It is therefore necessary for the HAS module to find the best compromise between the highest possible rendering quality, and therefore the highest possible encoding rate, and the time to download the segment, which must be short enough to permit continuous rendering on the television set TV.

First of all, the HAS module retrieves the manifest that corresponds to the video content item Cp in order to discover the available segments of the video content item Cp, and the various associated video qualities Nj. In the example of FIG. 4, the content item Cp is for example proposed in the form of segments having a duration of 3 s, with a first encoding rate N1=400 kb/s, a second encoding rate N2=800 kb/s, a third encoding rate N3=1200 kb/s, etc.

In a normal operating mode, which is not illustrated in FIG. 4, the HAS module downloads, for example, the successive segments C11@N1 (that is to say the first temporal segment at an encoding rate of 400 kb/s), then C12@N3 (that is to say the second temporal segment at an encoding rate of 1200 kb/s), then C13@N3 (that is to say the third temporal segment at an encoding rate of 1200 kb/s), etc.

The various segments downloaded by the HAS module are then transmitted to a display module, which is able to request for them to be displayed on a television screen.

The algorithm implemented by the HAS module to determine which segment must be downloaded at which encoding rate in normal operating mode is irrelevant to the disclosure. This algorithm will therefore not be described in more detail here.

When a user accesses a live stream that is broadcast in real time (live content) using HTTP adaptive streaming (HAS), the playback device STB, by which is implied the HAS entity installed on this device, retrieves, usually every 2 seconds, a manifest, called a real-time manifest below, which generally describes the last sixty seconds of the stream (30 segments of 2 seconds). A decision may then be taken to buffer a certain portion of the stream (up to 60 seconds maximum, therefore); the video segments are of short duration because it is desirable to be as close as possible to truly live, that is to say the event being filmed, for example a football match. It is also for this reason that the manifest is retrieved every two seconds and that buffer depth is usually limited to around fifteen seconds so as not to give rise to too great a lag between the football match and rendering thereof on a screen.

Instead of being played back by the playback device STB, the content item may also be recorded on an nPVR storage server with a view to possible subsequent playback by a playback device STB. This recording is often carried out upon request from the playback device STB. In this case, in our example, the principle of downloading from the server SRV and the nPVR storage server is the same as that described above between the server STRV and the playback device STB.

When recording to the nPVR server, as indicated in the section dedicated to the prior art, all segments are recorded to the nPVR server. However, the content item very often includes the “requested” content item, called main content item, and an “unrequested” or even undesired content item.

According to an aspect of the disclosure, following the receipt of a request to record the content item Cp, the method comprises recording segments or network addresses depending on whether the segments in question concern the main content item (Cp) or the secondary content item (Cs). The method comprises two phases:
A first phase during which the server SRV uploads manifests associated with the request to access the content item Cp to the nPVR storage server;
A second phase during which the playback device STB accesses the content item on the nPVR storage server.

With reference to FIG. 5, as indicated above, in the first phase, the nPVR server records the segments of the content item Cp or URLs depending on whether the content item is the main content item or the secondary content item. Implementation steps are described below:

In a first step, the playback device STB transmits a request REQ (Cp) to access the content item Cp. This request is conventional and will not be described further for this reason.

The server SRV receives the request and carries it out.

The server SRV transmits, in return, the manifests produced successively one after another to the nPVR storage server. In our example, the following files are transmitted: MNF1/MNF2/MNF3/ . . . /MNF(x)/MNF(x+1)/ . . . /MNF(k)/MNF (k+1)

X and k are positive integers

A management entity ENT present on the nPVR storage server, or external to the nPVR server and able to communicate with the nPVR server, is responsible for analyzing the manifests received by the nPVR server and detecting network addresses relating to the main content item and network addresses relating to a secondary content item. It should be clarified here that a secondary content item Cs concerns for example an advertisement, or a series of advertisements, commonly called an “advertisement tunnel”.

When the entity ENT receives the various manifests in succession, the management entity ENT detects, among the received network addresses, those concerning the main content item and those concerning the secondary content item.

It will be assumed that the manifests MNF1/MNF2/MNF3 and so on, up to the manifest MNF(x), concern the main content item. It will be assumed that the manifests MNF(x) and MNF(x+1) concern a secondary content item CS. It will also be assumed that the manifests MNF(x+2) and so on, including MNFk/MNF (k+1), concern the main content item Cp.

The preceding manifests are ordered chronologically according to their respective production date t_{MNFi}, i being an index used to place the instant in question “t” in time:

$${t}_{MNF 1} < {t}_{MNF 2} < {t}_{MNF 3} < … < {t}_{MNFx} < {t}_{MNF ( x + 1 )} < … < {t}_{MNFk} < {t}_{MNF ( k + 1 )}$$

Following the receipt of the first manifest MNF1, the nPVR server reads the file, detects that the content item in question is the main content item Cp, and downloads the segments described accordingly.

The management entity ENT carries out the same steps for the following manifests, up to the manifest MNF(x).

Following the receipt of this file MNF(x), the management entity ENT detects that segments described in this manifest MNF(x) concern a secondary content item Cs. In this case, the management entity ENT does not download the segments associated with the addresses described in this file, but instead stores the network addresses of the segments in question.

In the same way, the management entity ENT does not download the segments associated with the addresses described in the following file, but instead stores the network addresses of the segments in question. The entity continues the storage of network addresses until the addresses concern addresses relating to the main content item Cp, namely in our example up to the file MNF (k).

It will be assumed that the nPVR server now downloads the manifest MNF (k) and then the file MNF (k+1). In this case, with the manifest MNF (k) concerning the main content item Cp, the management entity ENT downloads the content segments again and stores them with a view to subsequent use; the same applies to the file MNF (k+1) received subsequently.

At this stage,
the segments S-Cp described in the manifests MNF1/MNF2/MNF3 and so on, up to the manifest MNF(x) in the order described above, are downloaded and stored with a view to subsequent playback;
the addresses ad-Cs of the segments of the secondary content item Cs are stored in the nPVR server.

It has been seen above that the management entity is capable of distinguishing network addresses associated with a main content item Cp from addresses associated with a secondary content item Cs. For example, the management entity ENT reads and detects, in the manifests, tags introducing one or more network addresses relating to a secondary content item Cs.

It should be noted that this FIG. 5 illustrates only some of the messages that are useful to understanding the disclosure. For example, after receipt of a manifest by the nPVR storage server, the latter in principle requests access to the segments described in this received manifest; it has been chosen not to show these access messages because they irrelevant to the disclosure.

In the second phase of accessing the recorded content item, the playback device STB accesses the nPVR server in order to play back a recorded content item.

When the recorded content item is played back, segments or network addresses recorded on the nPVR server are played back conventionally. More specifically, during playback, when the entity ENT downloads a network address linked to a secondary content item Cs, the management entity ENT requests access to the secondary content item associated with this address on the network. It should be understood here that the played-back secondary content item is not a secondary content item recorded on the nPVR server, but one recorded on another server storing secondary content items. If the secondary content issuer is able to update the secondary content items over time, the secondary content item accessed at a given time might not be the same secondary content item at another time. The secondary content item may therefore be chosen according to a child or adult user profile, the time when the content item Cp is accessed, etc.

The embodiment described above may have multiple variants.

According to one variant, the steps described above are carried out only for a subset of secondary content items. For example, some advertisement-type secondary content items may be advertisements provided over a lengthy duration by the secondary content issuer; in this case, the segments of such a secondary content item are recorded in the nPVR server.

Another possible variant would also be to delete a secondary content item after this secondary content item has been played back a given number of times, for example following a first viewing. This makes it possible to save memory space.

According to another variant, the URL network addresses stored in the nPVR server are erased from memory beyond a certain duration in order to save memory space.

According to another variant, the network addresses are replaced by segments of a secondary content item. In this variant, the management entity is capable of requesting storage of network addresses of secondary content items and replacement of these network addresses by segments at a later time.

It should be specified here that, with the initial secondary content item having a given duration, the secondary content item replacing it will ideally have the same duration. Since a secondary content item may combine multiple sub-content items, the sum of the duration of the sub-content items will be chosen to be ideally the same duration as the initial secondary content item.

If the duration of the replacement secondary content item is not the same, the playback device STB may request for the secondary content item currently being played pack to be sped up or slowed down.

Lastly, it should also be pointed out here that the term “entity” may correspond equally to a software component or to a hardware component or to a set of software and hardware components, a software component itself corresponding to one or more computer programs or subroutines or, more generally, to any element of a program able to implement a function or a set of functions such as described for the modules in question. In the same way, a hardware component corresponds to any element of a hardware assembly that is able to implement a function or a set of functions for the module in question (integrated circuit, chip card, memory card, etc.).

An exemplary aspect of the present disclosure improves the situation described with respect to the prior art.

```
APPENDIX 1
<?xml version=“1.0”?>
<MPD xmlns:xsi=“http://www.w3.org/2001/XMLSchema-instance”
  xmlns=“urn:mpeg:DASH:schema:MPD:2011”
  xsi:schemaLocation=“urn:mpeg:DASH:schema:MPD:2011 DASH-MPD.xsd”
  type=“dynamic” profiles=“urn:mpeg:dash:profile:isoff-live:2011”>
  <Representation id=“0” codecs=“avc1” mimeType=“video/mp4”
  width=“1024” height=“768” startWithSAP=“1” bandwidth=“46986”>
<BaseURL>HTTP://server.com/</BaseURL>
<!-- Contenu C1 à N1=512kb -->
  <SegmentBase>
      <Initialization sourceURL=“C1_15sec_512kb/C1_512kbit_dash.mp4”/>
</SegmentBase>
<SegmentList duration=“10”>
    <SegmentURL media=“C1_512kb_1.mp4”/>
    <SegmentURL media=“ C1_512kb _2.mp4”/> ....
</SegmentList>
<!-- Contenu C1 à N2=1024kb -->
<SegmentBase>
      <Initialization sourceURL=“C1_15sec_500kbit/C1_1024kbit_dash.mp4”/>
</SegmentBase>
<SegmentList duration=“10”>
    <SegmentURL media=“C1_512kb_1.mp4”/>....
</SegmentList>
<!-- Contenu C1 à N3=2048kb -->
<SegmentBase>
      <Initialization sourceURL=“C1_15sec_512kb /C1_2048kbit_dash.mp4”/>
</SegmentBase>
<SegmentList duration=“10”>
    <SegmentURL media=“C1_2048kb _1.mp4”/>...
</SegmentList>
<!-- Contenu C2 à N1=512kb -->
  <SegmentBase>
      <Initialization sourceURL=“ C2_15sec_500kbit/C2_512kbit_dash.mp4”/>
</SegmentBase>
<SegmentList duration=“10”>
    <SegmentURL media=“ C2_512kb_1.mp4”/> ....
</SegmentList>
<!-- Contenu C2 à N2=1024kb -->
<SegmentBase>
      <Initialization sourceURL=“C2_15sec_500kbit/C1_1024kbit_dash.mp4”/>
</SegmentBase>
<SegmentList duration=“10”>
    <SegmentURL media=“C2_1024kb_1.mp4”/>....
</SegmentList>
<!-- Contenu C2 à N3=2048kb -->
<SegmentBase>
      <Initialization sourceURL=“C2_15sec_500kbit/C1_2048kbit_dash.mp4”/>
</SegmentBase>
<SegmentList duration=“10”>
    <SegmentURL media=“C1_2048kbit _1.mp4”/>...
</SegmentList>
    ....
</SegmentList>
</MPD>
```

Although the present disclosure has been described with reference to one or more examples, workers skilled in the art will recognize that changes may be made in form and detail without departing from the scope of the disclosure and/or the appended claims.

What is claimed is:

1. A method implemented by a management device and comprising:
managing recording of a multimedia content item including a first content item, called main content item, and a second content item, called secondary content item, the main and secondary content items comprising temporal segments having respective network access addresses from which the segments are downloaded via a communication network, wherein the managing comprises:
receiving a request to record the content item; and
following the receipt of the request, recording the segments or the network addresses depending on whether the segments in question concern the main content item or the secondary content item.

2. The method according to claim 1, the segments are described in a manifest, and the method comprises distinguishing between described segments relating to the first content item and those relating to the secondary content item.

3. The method according to claim 2, wherein, in response to the secondary content item comprising a plurality of sub-content items, the transmission step is carried out only for some of the sub-content items.

4. The method according to claim 1, wherein the secondary content item changes over time.

5. The method according to claim 1, comprising erasing the recorded addresses from memory beyond a certain duration.

6. The method according to claim 5, comprising replacing the network addresses by segments of a secondary content item later on.

7. A management entity device comprising:
at least one processor; and
at least one non-transitory computer readable medium comprising instructions stored thereon which when executed by the at least one processor configure the management entity device to manage recording of a multimedia content item including a first content item, called main content item, and a second content item, called secondary content item, the main and secondary content items comprising temporal segments having respective network access addresses from which the segments are downloaded via a communication network, wherein the managing comprises:
receiving a request to record the content item; and
following receipt of the request, recording the segments or the network addresses depending on whether the segments in question concern the main content item or the secondary content item.

8. A storage server comprising the management entity device as defined in claim 7.

9. A multimedia content playback device comprising the management entity device as defined in claim 7.

10. A non-transitory computer readable medium comprising a computer program stored thereon, the program comprising code instructions that, when executed by at least one processor of a management entity device, carry out a method comprising:
managing recording of a multimedia content item including a first content item, called main content item, and a second content item, called secondary content item, the main and secondary content items comprising temporal segments having respective network access addresses from which the segments are downloaded via a communication network, wherein the managing comprises:
receiving a request to record the content item; and
following the receipt of the request, recording the segments or the network addresses depending on whether the segments in question concern the main content item or the secondary content item.
